(19) United States
(12) Patent Application Publication
(10) Pub. No.: US 2015/0096169 A1
(43) Pub. Date: Apr. 9, 2015

(54) SLURRY FOR POSITIVE ELECTRODE FOR SULFIDE-BASED SOLID-STATE BATTERY, POSITIVE ELECTRODE FOR SULFIDE-BASED SOLID-STATE BATTERY AND METHOD FOR MANUFACTURING THE SAME, AND SULFIDE-BASED SOLID-STATE BATTERY AND METHOD FOR MANUFACTURING THE SAME

(71) Applicants: Hajime Hasegawa, Susono-shi (JP); Hiroki Kubo, Susono-shi (JP); Yuichi Hashimoto, Numazu-shi (JP); Daichi Kosaka, Susono-shi (JP); Keisuke Watanabe, Tokyo (JP); Tamito Igarashi, Tokyo (JP); Mitsuyasu Sakuma, Tokyo (JP)

(72) Inventors: Hajime Hasegawa, Susono-shi (JP); Hiroki Kubo, Susono-shi (JP); Yuichi Hashimoto, Numazu-shi (JP); Daichi Kosaka, Susono-shi (JP); Keisuke Watanabe, Tokyo (JP); Tamito Igarashi, Tokyo (JP); Mitsuyasu Sakuma, Tokyo (JP)

(73) Assignees: KUREHA CORPORATION, Tokyo (JP); TOYOTA JIDOSHA KABUSHIKI KAISHA, Toyota-shi, Aichi-ken (JP)

(21) Appl. No.: 14/391,892

(22) PCT Filed: May 29, 2013
(86) PCT No.: PCT/IB2013/001077

§ 371 Date: Oct. 10, 2014

(30) Foreign Application Priority Data
May 31, 2012 (JP) 2012-124963
Oct. 10, 2012 (JP) 2012-225507

(51) Int. Cl. H01M 4/62; H01M 4/131; H01M 4/525; H01M 10/0562; H01M 10/058; H01M 4/505; H01M 4/04; H01M 4/1391

(52) U.S. Cl. CPC H01M 4/623; H01M 4/0407; H01M 4/131; H01M 4/1391; H01M 10/0562; H01M 10/058; H01M 4/505; H01M 4/525; H01M 2300/0068
USPC 29/623.5; 427/126.3; 252/182.1

(57) ABSTRACT

A slurry for a positive electrode for a sulfide-based solid-state battery contains at least a fluorine-based copolymer containing vinylidene fluoride monomer units, a positive electrode active material, and a solvent or a dispersion medium. When a dry volume of the slurry is set to 100% by volume, a content ratio of the fluorine-based copolymer is 1.5 to 10% by volume.

### BACKGROUND OF THE INVENTION

1. Field of the Invention

The invention relates to a slurry that forms a positive electrode used in a sulfide-based solid-state battery, a positive electrode for a sulfide-based solid-state battery and a method for manufacturing the same, and, a sulfide-based solid-state battery and a method for manufacturing the same.

2. Description of Related Art

A secondary battery is a battery that can convert a decrease in a chemical energy accompanying a chemical reaction into an electrical energy to be able to discharge, and, in addition thereto, when an electric current is flowed in a direction reversal to that during discharge, can convert an electrical energy into a chemical energy to be able to store (charge). Among secondary batteries, a lithium ion secondary battery has a high energy density; accordingly, it is broadly used as a power source of portable devices such as a laptop computer, a portable telephone and so on.

In a lithium secondary battery, when graphite (represented as C) is used as a negative electrode active material, during discharge, a reaction according to the following equation (I) proceeds at a negative electrode.

LiₓC→C+xLi⁺xe⁻ (I) (In the equation (I), 0<x<1).

Electrons generated according to a reaction of the equation (I) pass through an external circuit, and, after working with an external load, reach a positive electrode. Then, lithium ions (Li⁺) generated according to the reaction of the equation (I) move through an electrolyte sandwiched between a negative electrode and a positive electrode from a negative electrode side to a positive electrode side by electro-osmosis.

Further, when lithium cobalt oxide (Li₁₋ₓCoO₂) is used as a positive electrode active material, during discharge, a reaction according to the following equation (II) proceeds at a positive electrode.

Li₁₋ₓCoO₂+xLi⁺+xe⁻→LiCoO₂ (II) (In the equation (II), 0<x<1.)

During charge, at a negative electrode and a positive electrode, reversal reactions according to the equation (I) and the equation (II) respectively proceed at a negative electrode and a positive electrode. As a result, graphite that incorporated lithium by graphite intercalation (LiₓC) is regenerated at the negative electrode and lithium cobalt oxide (Li₁₋ₓCoO₂) is regenerated at the positive electrode. Accordingly, re-discharge becomes possible.

Among lithium secondary batteries, a lithium secondary battery where a solid electrolyte is used as an electrolyte and a battery is fully solidified does not use an inflammable organic solvent in a battery; accordingly, it is considered that safety and simplification of a device can be achieved and a production cost and productivity are sufficient. As a solid electrolyte material used in such the solid electrolyte, a sulfide-based solid electrolyte is known. In Japanese Patent Application Publication No. 2011-165650 (JP 20011-165650 A), a sulfide-based solid electrolyte battery is disclosed, in which at least any one of a positive electrode, a negative electrode and an electrolyte layer contains a sulfide-based solid electrolyte and a basic material is contained in a sulfide-based solid electrolyte battery.

In paragraph [0034] of a specification of JP 2011-165650 A, it is described that PVDF may be used as a binder of a positive electrode. However, there is a possibility that when a PVDF homopolymer is used, a sufficient battery output cannot be obtained.

### SUMMARY OF THE INVENTION

The invention provides a slurry that forms a positive electrode used in a sulfide-based solid-state battery, a positive electrode for a sulfide-based solid-state battery and a method for manufacturing the same, and, a sulfide-based solid-state battery and a method for manufacturing the same.

A slurry for a positive electrode for a sulfide-based solid-state battery according to a first aspect of the invention contains at least a fluorine-based copolymer containing vinylidene fluoride monomer units, a positive electrode active material, and a solvent or a dispersion medium. When a dry volume of the slurry is set to 100% by volume, a content ratio of the fluorine-based copolymer is 1.5 to 10% by volume.

In the slurry for a positive electrode for a sulfide-based solid-state battery according to the first aspect, a content ratio of the vinylidene fluoride monomer units in the fluorine-based copolymer may be 40 to 70% by mol.

In the slurry for a positive electrode for a sulfide-based solid-state battery according to the first aspect, the fluorine-based copolymer may further contain at least one fluorine-based monomer unit selected from the group consisting of a tetrafluoroethylene monomer unit, a hexafluoropropylene monomer unit, a vinyl fluoride monomer unit, a trifluoroethylene monomer unit, a chlorotrifluoroethylene monomer unit, a perfluoromethylvinylether monomer unit, and a perfluoroethylvinylether monomer unit.

In the slurry for a positive electrode for a sulfide-based solid-state battery according to the first aspect, a sulfide-based solid electrolyte may be contained.

In the slurry for a positive electrode for a sulfide-based solid-state battery according to the first aspect, the solvent or dispersion medium may contain an ester compound represented by the following formula.

R¹—CO₂—R²

In the formula, R¹ represents a straight-chain or branched-chain aliphatic group having 3 to 10 carbon atoms or an aromatic group having 6 to 10 carbon atoms, and, R² represents a straight-chain or branched-chain aliphatic group having 4 to 10 carbon atoms.

In the slurry for a positive electrode for a sulfide-based solid-state battery according to the first aspect, when the dry volume is set to 100% by volume, a content ratio of the fluorine-based copolymer may be 1.5 to 4.0% by volume.

A positive electrode for a sulfide-based solid-state battery according to a second aspect of the invention contains at least a fluorine-based copolymer containing vinylidene fluoride monomer units and a positive electrode active material. When a volume of the positive electrode for a sulfide-based solid-state battery is set to 100% by volume, a content ratio of the fluorine-based copolymer is 1.5 to 10% by volume.

In the positive electrode for a sulfide-based solid-state battery according to the second aspect, a content ratio of the vinylidene fluoride monomer units in the fluorine-based copolymer may be 40 to 70% by mol.

In the positive electrode for a sulfide-based solid-state battery according to the second aspect, the fluorine-based copolymer may further contain at least one fluorine-based monomer unit selected from the group consisting of a tetrafluoroethylene monomer unit, a hexafluoropropylene monomer unit, a vinyl fluoride monomer unit, a trifluoroethylene monomer unit, a chlorotrifluoroethylene monomer unit, a perfluoromethylvinylether monomer unit, and a perfluoroethylvinylether monomer unit.

In the positive electrode for a sulfide-based solid-state battery according to the second aspect, a sulfide-based solid electrolyte may be contained in the slurry.

In the positive electrode for a sulfide-based solid-state battery according to second aspect, when the volume of the positive electrode for a sulfide-based solid-state battery is set to 100% by volume, a content ratio of the fluorine-based copolymer may be 1.5 to 4.0% by volume.

A sulfide-based solid-state battery according to a third aspect of the invention is provided with a positive electrode, a negative electrode, and a sulfide-based solid-state electrolyte layer interposed between the positive electrode and the negative electrode. The positive electrode contains the positive electrode for a sulfide-based solid-state battery.

A method for manufacturing a positive electrode for a sulfide-based solid-state battery according to a fourth aspect of the invention is a method for manufacturing a positive electrode for a sulfide-based solid-state battery, the positive electrode including at least a positive electrode active material and a fluorine-based copolymer, the fluorine-based copolymer containing vinylidene fluoride monomer units. The method includes: preparing a base material; kneading at least the fluorine-based copolymer, the positive electrode active material, and a solvent or a dispersion medium to prepare a slurry, wherein when a dry volume of the slurry in a manufactured positive electrode for a sulfide-based solid-state battery is set to 100% by volume, a content ratio of the fluorine-based copolymer is 1.5 to 10% by volume in the slurry; and coating the slurry on at least one surface of the base material to form a positive electrode for a sulfide-based solid-state battery.

In the method for manufacturing a positive electrode for a sulfide-based solid-state battery according to the fourth aspect, a content ratio of the vinylidene fluoride monomer units in the fluorine-based copolymer may be 40 to 70% by mol.

In the method for manufacturing a positive electrode for a sulfide-based solid-state battery according to the fourth aspect, the fluorine-based copolymer may further contain at least one fluorine-based monomer unit selected from the group consisting of a tetrafluoroethylene monomer unit, a hexafluoropropylene monomer unit, a vinyl fluoride monomer unit, a trifluoroethylene monomer unit, a chlorotrifluoroethylene monomer unit, a perfluoromethylvinylether monomer unit, and a perfluoroethylvinylether monomer unit.

In the method for manufacturing a positive electrode for a sulfide-based solid-state battery according to the fourth aspect, the slurry may further contain a sulfide-based solid electrolyte.

In the method for manufacturing a positive electrode for a sulfide-based solid-state battery according to the fourth aspect, the solvent or dispersion medium may contain an ester compound represented by the formula.

In the method for manufacturing a positive electrode for a sulfide-based solid-state battery according to the fourth aspect, in the slurry, when the dry volume in a manufactured positive electrode for a sulfide-based solid-state battery is set to 100% by volume, a content ratio of the fluorine-based copolymer may be 1.5 to 4.0% by volume.

A method for manufacturing a sulfide-based solid-state battery according to a fifth aspect of the invention is a method for manufacturing a sulfide-based solid-state battery, the sulfide-based solid-state battery including a positive electrode, a negative electrode, and a sulfide-based solid electrolyte layer interposed between the positive electrode and the negative electrode. The method includes; preparing the negative electrode and the sulfide-based solid electrolyte layer; kneading at least a fluorine-based copolymer containing vinylidene fluoride monomer units, a positive electrode active material, and a solvent or a dispersion medium to prepare a slurry, wherein when a dry volume of the slurry in a manufactured sulfide-based solid-state battery is set to 100% by volume, a content ratio of the fluorine-based copolymer is 1.5 to 10% by volume in the slurry; and coating the slurry on one surface of the sulfide-based solid electrolyte layer to form a positive electrode and stacking the negative electrode on the other surface of the sulfide-based solid electrolyte layer to manufacture a sulfide-based solid-state battery.

In the method for manufacturing a sulfide-based solid-state battery according to the fifth aspect, a content ratio of the vinylidene fluoride monomer units in the fluorine-based copolymer may be 40 to 70% by mol.

In the method for manufacturing a sulfide-based solid-state battery according to the fifth aspect, the fluorine-based copolymer may further contain at least one fluorine-based monomer unit selected from the group consisting of a tetrafluoroethylene monomer unit, a hexafluoropropylene monomer unit, a vinyl fluoride monomer unit, a trifluoroethylene monomer unit, a chlorotrifluoroethylene monomer unit, a perfluoromethylvinylether monomer unit, and a perfluoroethylvinylether monomer unit.

In the method for manufacturing a sulfide-based solid-state battery according to the fifth aspect, the slurry may contain a sulfide-based solid electrolyte.

In the method for manufacturing a sulfide-based solid-state battery according to the fifth aspect, the solvent or dispersion medium may contain an ester compound represented by the formula.

In the method for manufacturing a sulfide-based solid-state battery according to the fifth aspect, when the dry volume in a manufactured sulfide-based solid-state battery is set to 100% by volume, a content ratio of the fluorine-based copolymer may be 1.5 to 4.0% by volume.

According to the aspects of the invention, in a battery manufactured with a slurry, a high battery output and a high adhesion force in a positive electrode can be ensured by setting a content ratio of a fluorine-based copolymer included in the slurry in an appropriate range.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram showing an example of a stacked structure of a sulfide-based solid-state battery manufactured according to an embodiment of the invention, which schematically shows a cross-section cut in a stacked direction;

FIG. 2 is a graph where adhesion forces of sulfide-based solid-state batteries of Example 1 to Example 3 and Comparative Example 1 to Comparative Example 3 are plotted;

FIG. 3 is a graph where output ratios of sulfide-based solid-state batteries of Example 1 to Example 3 and Comparative Example 1 to Comparative Example 4 are plotted;

FIG. 4 is a graph where output ratios are plotted with respect to adhesion forces of sulfide-based solid-state batteries of Example 1 to Example 3 and Comparative Example 1 to Comparative Example 3;

FIG. 5 is a graph where initial outputs and initial capacities of sulfide-based solid-state batteries of Example 4 to Example 6 are plotted;

FIG. 6 is a graph where outputs after endurance and capacities after endurance are plotted of sulfide-based solid-state batteries of Example 4 and Example 5; and

FIG. 7 is a sectional schematic diagram roughly showing a measurement mode of an adhesion force.

### DETAILED DESCRIPTION OF EMBODIMENTS

### Embodiments

### 1. Slurry for Positive Electrode for Sulfide-Based Solid-State Battery

A slurry for a positive electrode for a sulfide-based solid-state battery of a first embodiment of the invention contains at least a fluorine-based copolymer containing vinylidene fluoride monomer units, a positive electrode active material, and a solvent or a dispersion medium. When a dry volume of the slurry is set to 100% by volume, a content ratio of the fluorine-based copolymer is 1.5 to 10% by volume.

The inventors found, after studying hard, that a positive electrode for a sulfide-based solid-state battery, which was formed with a slurry containing a specific amount of a fluorine-based copolymer, the fluorine-based copolymer containing vinylidene fluoride monomer units, exerts sufficient adhesiveness. Furthermore, the inventors found that a sulfide-based solid-state battery where the positive electrode was used exerts a high output.

As is disclosed in JP 2011-165650 A, in a field of a technology of a sulfide-based solid-state battery, it has been known to use a polyvinylidene fluoride (PVDF) homopolymer or copolymer as a binder of a positive electrode. However, an example has not been known that a content ratio of a binder is stipulated from the viewpoint that adhesiveness of a positive electrode which a binder exerts contradicts a battery performance. By contrast, the inventors focused on a fluorine-based copolymer containing vinylidene fluoride monomer units and studied an optimum content ratio of the fluorine-based copolymer. As a result thereof, it was found that when a dry volume of a slurry for a positive electrode for sulfide-based solid-state battery is set to 100% by volume, sufficient adhesiveness of a positive electrode is combined with a high battery output by setting a content ratio of the fluorine-based copolymer to 1.5 to 10% by volume.

A fluorine-based copolymer containing vinylidene fluoride monomer units (hereinafter, in some cases, referred to as a fluorine-based copolymer) mainly serve as a binder in the first embodiment of the invention. In the first embodiment of the invention, a monomer unit indicates a repeating structural unit of a polymer. A fluorine-based copolymer is specifically dissolved or dispersed in a solvent or a dispersion medium in a slurry for a positive electrode for a sulfide-based solid-state battery (hereinafter, in some cases, referred to as a slurry). The fluorine-based copolymer works for binding a positive electrode material such as a positive electrode active material and so on in a positive 6 electrode for a sulfide-based solid-state battery. When a slurry for a positive electrode for a sulfide-based solid-state battery according to the first embodiment of the invention contains a sulfide-based solid electrolyte, a fluorine-based copolymer used in the first embodiment of the invention does not preferably react with the sulfide-based solid electrolyte.

A content ratio of vinylidene fluoride monomer units in a fluorine-based copolymer is preferably 40 to 70% by mol. When the content ratio of vinylidene fluoride monomer units is less than 40% by mol, the solubility of the fluorine-based copolymer in an organic solvent such as N-methyl pyrrolidone (NMP), butyl lactate or the like may decrease. Alternatively, the adhesiveness between a current collector and a positive electrode obtained with a slurry related to the first embodiment of the invention, in particular, the adhesiveness between a current collector and a positive electrode active material layer may decrease. On the other hand, when the content ratio of vinylidene fluoride monomer units exceeds 70% by mol, the solubility or dispersibility in a solvent or a dispersion medium may deteriorate. A content ratio of vinylidene fluoride monomer units in a fluorine-based copolymer in the first embodiment of the invention indicates a ratio of mole number of vinylidene fluoride monomer units when a sum total of mole number of monomer units constituting a fluorine-based copolymer is set to 100% by mol. A content ratio of vinylidene fluoride monomer units in a fluorine-based copolymer can be calculated according to a known method from an integration ratio of the respective signals of a ¹⁹FNMR spectrum, for example. A content ratio of vinylidene fluoride monomer units in a fluorine-based copolymer is preferably 45 to 65% by mol and more preferably 50 to 60% by mol.

A fluorine-based copolymer contains other fluorine-based monomer unit together with vinylidene fluoride monomer units. The fluorine-based monomer unit here is a monomer unit that contains a main chain skeleton constituted by a carbon-carbon bond (the main chain here contains a polymer-like side chain such as a graft chain) and a fluorine atom directly or indirectly bonded to a carbon atom constituting a main chain skeleton. Furthermore, the fluorine-based copolymer unit has a chemical structure where a large part of a spatial extent of a monomer unit is occupied by a carbon atom and a fluorine atom. Examples of fluorine-based monomer units other than vinylidene fluoride monomer units include a tetrafluoroethylene monomer unit, a hexafluoropropylene monomer unit, a vinyl fluoride monomer unit, a trifluoroethylene monomer unit, a chlorotrifluoroethylene monomer unit, a perfluoromethylvinylether monomer unit, and a perfluoroethylvinylether monomer unit. Among these fluorine-based monomer units, in particular, at least one of a tetrafluoroethylene monomer unit and a hexafluoropropylene monomer unit is preferably contained.

Examples of the fluorine-based copolymers that can be used in the first embodiment of the invention include a vinylidene fluoride-hexafluoropropylene copolymer, a vinylidene fluoride-chlorotrifluoroethylene copolymer, a vinylidene fluoride-tetrafluoroethylene-hexafluoropropylene copolymer, and a vinylidene fluoride-perfluoromethylvinylether-tetrafluoroethylene copolymer. Among these fluorine-based copolymers, a vinylidene fluoride-tetrafluoroethylene-hexafluoropropylene copolymer is preferably used.

A fluorine-based copolymer may be a block copolymer where blocks in each of which vinylidene fluoride monomer units and another fluorine-based monomer unit are linked in the same repeating unit by a definite number are copolymerized with each other. Alternatively, the fluorine-based copolymer may be an alternate copolymer where different repeating units are alternately polymerized. Further, a fluorine-based copolymer may be a random copolymer where repeating units are utterly randomly arranged.

It is preferable that a fluorine-based copolymer is not dissolved in water. Further, in particular, when a sulfide-based solid electrolyte described below is used, a moisture content contained in the fluorine-based copolymer is preferably 100 ppm or less. When a sulfide-based solid electrolyte reacts with water to generate hydrogen sulfide, ionic conductivity of the electrolyte may be deteriorated or the hydrogen sulfide may affect a positive electrode material in a slurry.

In the first embodiment of the invention, it is one of main features that when a dry volume of a slurry is set to 100% by volume, a content ratio of a fluorine-based copolymer is 1.5 to 10% by volume. When the content ratio of a fluorine-based copolymer is set to less than 1.5% by volume, the content ratio of the fluorine-based copolymer is too scarce; accordingly, adhesiveness of the resulted positive electrode for a sulfide-based solid-state battery becomes insufficient to may result in trouble in forming a positive electrode for a sulfide-based solid-state battery. On the other hand, when the content ratio of the fluorine-based copolymer is set exceeding 10% by volume, the content ratio of the fluorine-based copolymer is too much; accordingly, an output of a sulfide-based solid-state battery prepared with the slurry may decrease. A value of a volume ratio (% by volume) in the first embodiment of the invention indicates a value under room temperature (15 to 30° C.). Further, a value of a volume ratio (% by volume) in the first embodiment of the invention can be calculated from masses and true densities of respective members and materials to be used. Further, in the first embodiment of the invention, a “dry volume (of slurry)” indicates, in a sulfide-based solid-state battery or a positive electrode for a sulfide-based solid-state battery to be manufactured, a volume of a solid content that remains after the slurry is dried. A dry volume indicates more specifically a volume after a solvent and a dispersion medium are distilled away from the slurry.

When a dry volume of the slurry is set to 100% by volume, a content ratio of the fluorine-based copolymer is preferably 1.5 to 4.0% by volume. When the content ratio of the fluorine-based copolymer exceeds 4.0% by volume, as will be shown in Examples described below, in the case where the slurry according to the first embodiment of the invention is used in a sulfide-based solid-state battery, as a result of a deterioration of an initial performance of the sulfide-based solid-state battery, a capacity and an output may deteriorate. When a dry volume of a slurry is set to 100% by volume, a content ratio of a fluorine-based copolymer is preferably 2.0% by volume or more and more preferably 3.0% by volume or more. Further, when a dry volume of a slurry is set to 100% by volume, a content ratio of a fluorine-based copolymer is more preferably 3.5% by volume or less.

Specific examples of positive electrode active materials used in the first embodiment of the invention include LiCoO₂, LiNi₂Co₁₅Al₃O₂, Li₁₊ₓNi_{1/3}Mn_{1/3}Co_{1/3}O₂ (x represents a real number equal to zero or more), LiNiO₂, LiMn₂O₄, LiCoMnO₄, Li₂NiMn₃O₈, Li₃Fe₂(PO₄)₃, Li₃V₂(PO₄)₃, different-kind element substituted Li—Mn spinel having a composition represented by Li₁₊ₓMn_{2-x-y}M_{y}O₄ (M is at least one kind of metal selected from the group consisting of Al, Mg, Co, Fe, Ni, and Zn), lithium titanate (LiₓTiO_{y}), metal lithium phosphate having a composition represented by LiMPO₄ (M represents Fe, Mn, Co or Ni) and the like. Among these, in the first embodiment of the invention, LiCoO₂, LiNi₂Co₁₅Al₃O₂, and Li₁₊ₓNi_{1/3}Mn_{1/3}Co_{1/3}O₂ are preferably used as a positive electrode active material. In the first embodiment of the invention, a positive electrode active material obtained by coating the material for a positive electrode active material with a coating material may be used. A coating material that can be used in the first embodiment of the invention may contain a substance that has lithium ion conductivity and can maintain a form of a cover layer that does not flow even when coming into contact with an electrode active material or a solid electrolyte. Examples of the coating materials include LiNbO₃, Li₄Ti₅O₁₂, Li₃PO₄ and the like.

An average particle size of a positive electrode active material is, for example, 1 to 50 μm, preferably, 1 to 20 μm, and further preferably 3 to 7 μm. This is because when an average particle size of a positive electrode active material is too small, handling properties thereof may deteriorate, and, when an average particle size of a positive electrode active material is too large, it is difficult to obtain a flat positive electrode active material layer. An average particle size of a positive electrode active material can be obtained by measuring particle sizes of active material carriers observed by, for example, a scanning electron microscope (SEM) and by averaging.

A solvent or a dispersion medium used in the first embodiment of the invention (hereinafter, in some cases, referred to as a solvent or the like) functions to uniformly dissolve or disperse a fluorine-based copolymer and a positive electrode material such as a positive electrode active material and so on to uniformly maintain a composition in a slurry. The solvent or the like used in the first embodiment of the invention is not particularly restricted as long as it can dissolve or disperse the fluorine-based copolymer and a positive electrode material such as a positive electrode active material and so on. When a sulfide-based solid electrolyte that is described below is used, the solvent or the like is preferable not to adversely affect on the ionic conductivity that the sulfide-based solid electrolyte imparts to the slurry. NMP that is a solvent that has been used for preparing a solid-state battery material is not preferable because it tends to react with a sulfide-based solid electrolyte.

The solvent or the like preferably contains an ester compound represented the following formula (1).

R¹—CO₂—R² Formula (1)

In the formula (1), R¹ represents a straight-chain or branched-chain aliphatic group having 3 to 10 carbon atoms or an aromatic group having 6 to 10 carbon atoms, and, R² represents a straight-chain or branched-chain aliphatic group having 4 to 10 carbon atoms. When the R¹ represents an aliphatic group having 2 or less carbon atoms, the ionic conductivity when mixed with a sulfide-based solid electrolyte may deteriorate. Further, when R¹ represents an aliphatic group having 11 or more carbon atoms, an ester compound may not be able to disperse the fluorine-based copolymer and a positive electrode active material. Examples of preferable ester compounds used in the first embodiment of the invention include butyl butyrate, butyl pentanoate, butyl hexanoate, pentyl butyrate, pentyl pentanoate, pentyl hexanoate, hexyl butyrate, hexyl pentanoate, or hexyl hexanoate. These ester compounds (aliphatic acid esters) may be used singularly or in a combination of two or more kinds thereof. Among these ester compounds, butyl butyrate is preferably used and n-butyric acid n-butyl is more preferably used.

When a total weight of the slurry is set to 100% by weight, a content ratio of the solvent or the like is preferably 35 to 90% by weight. When the content ratio of the solvent or the like is less than 35% by weight, the content ratio of the solvent or the like is too scarce; accordingly, a fluorine-based copolymer, a positive electrode active material and so on are not dissolved or dispersed in the solvent or the like to may result in causing a trouble when a positive electrode for a sulfide-based solid-state battery is formed. On the other hand, when the content ratio of the solvent or the like exceeds 90% by weight, the content ratio of the solvent or the like is too abundant; accordingly, it may be difficult to control a basis weight (coating). A content ratio of the solvent or the like when a total weight of the slurry is set to 100% by weight is more preferably 40 to 70% by weight and still more preferably 50 to 65% by weight. A solid content rate in the slurry is preferably 10 to 65% by weight.

The solvent or the like is preferably nonaqueous. Further, in particular when a sulfide-based solid electrolyte described below is used, a moisture content contained in the solvent or the like is preferably 100 ppm or less. This is because when a sulfide-based solid electrolyte reacts with water to generate hydrogen sulfide, the ionic conductivity of the electrolyte may be deteriorated or the hydrogen sulfide may decompose a positive electrode material in the slurry.

A slurry for a positive electrode for a sulfide-based solid-state battery according to the first embodiment of the invention preferably further contains a sulfide-based solid electrolyte. The sulfide-based solid electrolyte is known to react with water, a compound that has a functional group having high polarity and containing an oxygen atom (for example, alcohols such as methanol and the like, esters such as ethyl acetate and the like, amides such as N-methyl pyrrolidone and the like) or the like to decrease the ionic conductivity by 3 orders or more. Accordingly, when a conventional slurry for a positive electrode for a sulfide-based solid-state battery is prepared, only solvents having a functional group that does not contain an oxygen atom have been used. Further, from the viewpoint of handling properties, as a binder, only a few kinds of binders that can be dissolved in the solvents have been used, that is, a range of material selection was narrow. However, in the first embodiment of the invention, both a fluorine-based copolymer and an ester compound that can be favorably used are difficult to react with the sulfide-based solid electrolyte. Accordingly, a fluorine-based copolymer, and preferably together with an ester compound, and a sulfide-based solid electrolyte may be appropriately combined.

A sulfide-based solid electrolyte used in the first embodiment of the invention is not particularly limited as long as it is a solid electrolyte that contains a sulfur atom in a molecular structure or a composition. A sulfide-based solid electrolyte used in the first embodiment of the invention is preferably a glass or glass-ceramic like solid electrolyte having a sulfide as a main composition. Specific examples of the sulfide-based solid electrolytes used in the first embodiment of the invention include Li₂S—P₂S₅, Li₂S—P₂S₃, Li₂S—P₂S₃—P₂S₅, Li₂S—SiS₂, LiI—Li₂S—SiS₂, LiI—Li₂S—P₂S₅, LiI—Li₂S—P₂O₅, LiI—Li₃PO₄—P₂S₅, LiI—Li₂S—SiS₂—P₂S₅, Li₂S—SiS₂—Li₄SiO₄, Li₂S—SiS₂—Li₃PO₄, Li₃PS₄—Li₄GeS₄, Li_{3.4}P_{0.6}Si_{0.4}S₄, Li_{3.25}P_{0.25}Ge_{0.76}S₄, Li₄₋ₓGe₁₋ₓPₓS₄ and the like.

In the case where a sulfide-based solid electrolyte is used, it is preferable that, when a dry volume of a slurry is set to 100% by volume, a content ratio of a positive electrode active material is 10 to 80% by volume and a content ratio of a sulfide-based solid electrolyte is 20 to 70% by volume. This is because when the content ratio of a positive electrode active material is less than 10% by volume, a battery that used the slurry may not have sufficient charge-discharge performance. On the other hand, when the content ratio of the sulfide-based solid electrolyte is less than 20% by volume, a battery that used the slurry may not have sufficient ionic conductivity.

A slurry for a positive electrode for a sulfide-based solid-state battery of the first embodiment of the invention may further contain, as required, a conductive auxiliary agent. A conductive auxiliary agent used in the first embodiment of the invention is not particularly limited as long as it can improve conductivity in a target positive electrode for a sulfide-based solid-state battery. Examples of the conductive auxiliary agents include carbon blacks such as acetylene black, Ketjen black and the like; carbon fibers such as a carbon nanotube, a carbon nano-fiber, a vapor growth carbon fiber (VGCF) and the like; metal powders such as SUS powder, aluminum powder and the like; and the like.

A slurry may contain a material other than the above-described materials. However, a content ratio of the materials is, when a volume of an entire slurry is set to 100% by volume, preferably 4% by volume or less, more preferably 3% by volume or less.

### 2. Positive Electrode for Sulfide-Based Solid-State Battery

A positive electrode for a sulfide-based solid-state battery of the second embodiment of the invention is a positive electrode for a sulfide-based solid-state battery, which contains a positive electrode active material and at least a fluorine-based copolymer that contains vinylidene fluoride monomer units, wherein when a volume of the positive electrode for a sulfide-based solid-state battery is set to 100% by volume, a content ratio of the fluorine-based copolymer is 1.5 to 10% by volume.

A positive electrode for a sulfide-based solid-state battery according to the second embodiment of the invention may be composed of a fluorine-based copolymer and a positive electrode active material layer, wherein the fluorine-based copolymer contains vinylidene fluoride monomer units and the positive electrode active material layer contains a positive electrode active material. In addition to the positive electrode active material layer, a positive electrode for a sulfide-based solid-state battery according to the second embodiment of the invention may be provided with a positive electrode current collector and a positive electrode lead connected to the positive electrode current collector. When a positive electrode for a sulfide-based solid-state battery according to the second embodiment of the invention is provided with a member that does not contain a fluorine-based copolymer and a positive electrode active material such as a positive electrode current collector, a positive electrode lead and so on, “a volume of a positive electrode for a sulfide-based solid-state battery” means a volume of a portion containing a fluorine-based copolymer and a positive electrode active material (preferably a positive electrode active material layer) except for these positive electrode current collector, positive electrode lead and so on. As to a fluorine-based copolymer, a positive electrode active material and a solvent or a dispersion medium, the situation is the same as that of the slurry for a positive electrode for a sulfide-based solid-state battery. While a content ratio of a fluorine-based copolymer is in a slurry a ratio when a dry volume of the slurry is set to 100% by volume, in a positive electrode, it is a ratio when a volume of a positive electrode (preferably a volume of a positive electrode active material layer) is set to 100% by volume. Further, a positive electrode for a sulfide-based solid-state battery according to the second embodiment of the invention preferably further contains a sulfide-based solid electrolyte. The situation of a sulfide-based solid electrolyte used in the second embodiment of the invention is the same as that of the slurry for a positive electrode for a sulfide-based solid-state battery.

A thickness of a positive electrode active material layer used in the second embodiment of the invention is, though different depending on a target use of a sulfide-based solid-state battery, preferably 10 to 250 μm, more preferably 20 to 200 μm and particularly preferably 30 to 150 μm.

A positive electrode current collector used in the second embodiment of the invention is not particularly limited as long as it has a function of collecting a current of the positive electrode active material layer. Examples of materials of a positive electrode current collector include aluminum, steel use stainless (SUS), nickel, iron, titanium, chromium, gold, platinum, zinc and so on. Among these, aluminum and SUS are preferable. Further, as a shape of a positive electrode current collector, for example, a foil shape, a plate shape, a mesh shape and so on can be cited. Among these, a foil shape is preferable.

A positive electrode for a sulfide-based solid-state battery according to the second embodiment of the invention can exert a sufficient adhesion force by setting a content ratio of a fluorine-based copolymer to 1.5 to 10% by volume of a positive electrode for a sulfide-based solid-state battery (preferably a positive electrode active material layer). Also, a sulfide-based solid-state battery that used the positive electrode can exert a high output.

### 3. Method for Manufacturing Positive Electrode for Sulfide-Based Solid-State Battery

A method for manufacturing a positive electrode for a sulfide-based solid-state battery of the third embodiment of the invention is a method for manufacturing a positive electrode for a sulfide-based solid-state battery, the positive electrode at least containing a positive electrode active material and a fluorine-based copolymer containing vinylidene fluoride monomer units. The method includes: preparing a base material; kneading at least the fluorine-based copolymer, the positive electrode active material, and a solvent or a dispersion medium to prepare a slurry where, when a dry volume in a positive electrode for a manufactured sulfide-based solid-state battery is set to 100% by volume, a content ratio of the fluorine-based copolymer is 1.5 to 10% by volume; and coating the slurry on at least one surface of the base material to form a positive electrode for a sulfide-based solid-state battery.

The third embodiment of the invention includes (3-1) preparing a base material, (3-2) preparing a slurry, and (3-3) coating the slurry to form a positive electrode for a sulfide-based solid-state battery. However, the third embodiment of the invention is not necessarily limited only to the three steps. Hereinafter, the steps (3-1) to (3-3) will be sequentially described.

### 3-1. Step of Preparing Base Material

A base material used in the third embodiment of the invention is not particularly limited as long as it has a flat surface to an extent that allows to coat a slurry. The base material may have a plate shape or a sheet shape. Further, the base material may be prepared in advance or a commercially available product. The base material used in the third embodiment of the invention may be used for a sulfide-based solid-state battery after a positive electrode for a sulfide-based solid-state battery was formed or may not be used as a material for a sulfide-based solid-state battery. Examples of the base materials used in a sulfide-based solid-state battery include electrode materials such as a positive electrode current collector and the like, a material for a sulfide-based solid electrolyte layer such as a sulfide-based solid electrolyte membrane and the like, and so on. Examples of materials that do not form a sulfide-based solid-state battery include transfer base materials such as a transfer sheet, a transfer substrate and the like. When a positive electrode for a sulfide-based solid-state battery formed on a transfer base material is joined with a sulfide-based solid electrolyte layer by thermocompression bonding or the like and after that the transfer base material is peeled, a positive electrode for a sulfide-based solid-state battery is formed on a sulfide-based solid electrolyte layer. Further, when a positive electrode for a sulfide-based solid-state battery formed on a transfer base material is joined with a positive electrode current collector by thermocompression bonding and after that the transfer base material is peeled, a positive electrode for a sulfide-based solid-state battery is formed on a positive electrode current collector.

### 3-2. Step of Preparing Slurry

The step is a step of kneading at least the fluorine-based copolymer, the positive electrode active material, and the solvent or the dispersion medium to prepare a slurry where, when a dry volume of a slurry in a positive electrode for a manufactured sulfide-based solid-state battery is set to 100% by volume, a content ratio of the fluorine-based copolymer is 1.5 to 10% by volume. A fluorine-based copolymer, a positive electrode active material, and a solvent or a dispersion medium, which are used in the step, are as described above. Further, in the step, the sulfide-based solid electrolyte may be further mixed in a slurry. A slurry prepared in the step is the same as the slurry for a positive electrode for a sulfide-based solid-state battery according to the above-described third embodiment of the invention. A thickener may be appropriately added to a slurry.

A method for kneading a fluorine-based copolymer, a positive electrode active material, a sulfide-based solid electrolyte, and a solvent or the like is not particularly limited as long as it can uniformly mix these materials. As a method for kneading these materials, for example, kneading with a mortar, and mechanical milling such as ball mill and the like can be cited. However, the method is not necessarily limited to these methods. Further, before and/or after kneading, a dispersion means such as ultrasonic dispersion or the like may be used to make a composition in a slurry homogeneous.

### 3-3. Step of Coating Slurry to Form Positive Electrode for Sulfide-Based Solid-State Battery

The step is a step of coating the slurry on at least one surface of the base material to form a positive electrode for a sulfide-based solid-state battery. A positive electrode for a sulfide-based solid-state battery may be formed on only one surface of a base material or may be formed on both surfaces of the base material.

A coating method, a drying method and so on of a slurry can be appropriately selected. Examples of the coating methods include a spray method, a screen printing method, a doctor blade method, a bar coat method, a roll coat method, a gravure printing method, a die coat method and so on. Further, examples of the drying methods include reduced-pressure drying, drying by heating, drying by heating under reduced pressure and so on. There is no limitation on a specific condition in reduced pressure drying and drying by heating, that is, a condition can be appropriately set. Although a coating amount of the slurry is different depending on a slurry composition, a target use of a positive electrode for a sulfide-based solid-state battery and so on, it may be set to about 5 to 30 mg/cm² in a dry state. Further, a thickness of a positive electrode for a sulfide-based solid-state battery may be about 10 to 250 pun without particular limitation.

### 4. Sulfide-Based Solid-State Battery

A sulfide-based solid-state battery of the fourth embodiment of the invention is a sulfide-based solid-state battery that is provided with a positive electrode, a negative electrode, and a sulfide-based solid electrolyte layer interposed between the positive electrode and the negative electrode, wherein the positive electrode contains the positive electrode for a sulfide-based solid-state battery.

FIG. 1 is a diagram showing an example of a stacked structure of a sulfide-based solid-state battery according to the fourth embodiment of the invention, wherein a cross-section cut in a stacked direction is schematically shown. A sulfide-based solid-state battery according to the fourth embodiment of the invention is not necessarily limited to this example. A sulfide-based solid-state battery 100 includes a positive electrode 6 provided with a positive electrode, active material layer 2 and a positive electrode current collector 4, a negative electrode 7 provided with a negative electrode active material layer 3 and a negative electrode current collector 5, and a sulfide-based solid electrolyte layer 1 interposed between the positive electrode 6 and the negative electrode 7. A positive electrode used in the fourth embodiment of the invention is the same as the positive electrode for a sulfide-based solid-state battery described above. Hereinafter, a negative electrode and a sulfide-based solid electrolyte layer, which are used in a sulfide-based solid-state battery according to the fourth embodiment of the invention will be described in detail. In addition to the negative electrode and the sulfide-based solid electrolyte layer, a separator and a battery case preferably which are used in a sulfide-based solid-state battery according to the fourth embodiment of the invention will also be described in detail.

A negative electrode used in the fourth embodiment of the invention is preferably provided with a negative electrode active material layer containing a negative electrode active material. A negative electrode used in the fourth embodiment of the invention is preferably provided with, in addition to the negative electrode active material layer, a negative electrode current collector and a negative electrode lead connected to the negative electrode current collector.

A negative electrode active material used in a negative electrode active material layer is not particularly limited as long as it can store and release a metal ion. When a lithium ion is used as a metal ion, for example, a lithium alloy, a metal oxide, a carbon material such as graphite, hard carbon or the like, silicon and a silicon alloy, Li₄Ti₅O₁₂, aluminum and so on can be cited. Further, a negative electrode active material may be in a form of powder or a thin film.

A negative electrode active material layer may, as required, contain a binder and the conductive auxiliary agent described above. As a binder used in a negative electrode active material layer, for example, rubber-based binders such as butylene rubber (BR), styrene-butadiene rubber (SBR), amino modified hydrogenated butadiene rubber (ABR) and the like can be cited. Further, a content ratio of a binder in a negative electrode active material layer may be an amount to an extent that can solidify a negative electrode active material and so on, and is preferable to be more scarce. A content ratio of the binder is usually 0.3 to 10% by weight. Further, as a binder used in the fourth embodiment of the invention, the fluorine-based copolymer may be used.

As a negative electrode active material that a negative electrode used in the fourth embodiment of the invention contains, a solid electrolyte can be used. As a solid electrolyte, specifically, other than the sulfide-based solid electrolyte described above, an oxide-based solid electrolyte, and a crystalline oxide/oxynitride can be used. Specific examples of oxide-based solid electrolytes include LiPON (lithium phosphate oxynitride), Li₂O—B₂O₃—P₂O₅, Li₂O—SiO₂, Li_{1.3}Al_{0.3}Ti_{0.7}(PO₄)₃, La_{0.51}Li_{0.34}TiO_{0.74}, Li₃PO₄, Li₂SiO₂, Li₂SiO₄, Li_{0.5}La_{0.5}TiO₃, Li_{1.5}Al_{0.5}Ge_{1.5}(PO₄)₃ and so on. Specific examples of crystalline oxide/oxynitrides include LiI, Li₃N, Li₅La₃Ta₂O₁₂, Li₇La₃Zr₂O₁₂, Li₆BaLa₂Ta₂O₁₂, Li₃PO_{(4-3/2w)}N_{w} (w<1), Li_{3.6}Si_{0.6}P_{0.4}O₄ and so on.

A film thickness of a negative electrode active material layer is not particularly limited but is, for example, 5 to 150 μm and particularly preferably 10 to 80 μm. After a negative electrode active material layer is formed, the negative electrode active material layer may be pressed to improve an electrode density.

A negative electrode current collector used in the fourth embodiment of the invention is not particularly limited as long as it has a function of collecting a current of the negative electrode active material layer. Examples of materials of the negative electrode current collector include chromium, SUS, nickel, iron, titanium, copper, cobalt, zinc and so on. Among these, copper, iron and SUS are preferable. Further, as a shape of a negative electrode current collector, for example, a foil shape, a plate shape, a mesh shape and so on can be cited. Among these, a foil shape is preferable.

A sulfide-based solid electrolyte layer used in the fourth embodiment of the invention is not particularly limited as long as it is a layer that contains the sulfide-based solid electrolyte. A sulfide-based solid electrolyte layer used in the fourth embodiment of the invention is preferably a layer constituted by the sulfide-based solid electrolyte.

A sulfide-based solid-state battery of the fourth embodiment of the invention may be provided with a separator between a positive electrode and a negative electrode. As the separator, for example, a porous film of polyethylene, polypropylene or the like; a resinous nonwoven fabric of polypropylene or the like; and a glass fiber nonwoven fabric can be cited.

A sulfide-based solid-state battery of the fourth embodiment of the invention may be further provided with a battery case. A shape of a battery case used in the fourth embodiment of the invention is not particularly limited as long as it can house the positive electrode, negative electrode, sulfide-based solid electrolyte layer and so on. Specifically, a cylinder type, a rectangle type, a coin type, a laminate type and so on can be cited.

### 5. Method for Manufacturing Sulfide-Based Solid-State Battery

A method for manufacturing a sulfide-based solid-state battery of the fifth embodiment of the invention is a method for manufacturing a sulfide-based solid-state battery that is provided with a positive electrode, a negative electrode, and a sulfide-based solid electrolyte layer interposed between the positive electrode and the negative electrode. The method includes: preparing the negative electrode and the sulfide-based solid electrolyte layer; kneading at least a fluorine-based copolymer containing vinylidene fluoride monomer units, a positive electrode active material, and a solvent or a dispersion medium to prepare a slurry where, when a dry volume of the slurry in a manufactured sulfide-based solid-state battery is set to 100% by volume, a content ratio of the fluorine-based copolymer is 1.5 to 10% by volume; and coating the slurry on one surface of the sulfide-based solid electrolyte layer to form a positive electrode and stacking the negative electrode on the other surface of the sulfide-based solid electrolyte layer to manufacture a sulfide-based solid-state battery.

The fifth embodiment of the invention includes (5-1) preparing a negative electrode and a sulfide-based solid electrolyte layer, (5-2) preparing a slurry, and (5-3) coating the slurry on one surface of the sulfide-based solid electrolyte layer to form a positive electrode and stacking the negative electrode on the other surface of the sulfide-based solid electrolyte layer to manufacture a sulfide-based solid-state battery. However, the fifth embodiment of the invention is not necessarily limited only to the three steps (5-1), (5-2) and (5-3). Other than the three steps, for example, the fifth embodiment of the invention may include housing a sulfide-based solid-state battery in the battery case. A negative electrode and a sulfide-based solid electrolyte layer prepared in the step (5-1) are as described above. Further, the step (5-2) is the same as that described in “3-2. Step of Preparing Slurry”. In the step (5-3), a method for coating a slurry on an electrolyte layer is as described above. After the step (5-3), in order to improve ionic conductivity of the respective interfaces between the respective electrodes and a sulfide-based solid electrolyte layer, a stacked body may be appropriately pressure bonded by thermocompression bonding or the like.

### EXAMPLES AND COMPARATIVE EXAMPLES

Hereinafter, with reference to Examples and Comparative Examples, the embodiments of the invention will be more specifically described. However, the embodiments of the invention is not limited only to these Examples.

### 1. Manufacture of Sulfide-Based Solid-State Battery

### Example 1

As a positive electrode active material, a ternary active material LiCo_{1/3}Ni_{1/3}Mn_{1/3}O₂ (obtained from Nichia Corporation) was used; as a binder, a fluorine-based copolymer (vinylidene fluoride monomer unit:tetrafluoroethylene monomer unit:hexafluoropropylene monomer unit=55% by mol: 25% by mol: 20% by mol, manufactured by Kureha Corporation) was used; as a sulfide-based solid electrolyte, LiI—Li₂O—Li₂S—P₂S₅ was used; as an auxiliary agent, a vapor phase growth carbon fiber (VGCF, manufactured by Showa Denko K. K.) was used; and as a solvent, butyl butyrate that is a kind of ester compound was used. A positive electrode active material, a butyl butyrate solution of 5% by weight of a binder, a sulfide-based solid electrolyte, and butyl butyrate (manufactured by Tokyo Kasei Kogyo Co., Ltd.) were mixed so that a solid content may be 63% by weight. The resulted mixture was subjected to ultrasonic treatment for 60 seconds with an ultrasonic homogenizer (manufactured by SMT Corporation, UH-50) and further stirred for 30 minutes with a shaker to prepare a slurry for a positive electrode for a sulfide-based solid-state battery. A content ratio in a dry volume of a slurry for a positive electrode for a sulfide-based solid-state battery was a positive electrode active material:a sulfide-based solid electrolyte:a binder:an conductive auxiliary agent=56.6% by volume:37.8% by volume:1.5% by volume:4.1% by volume.

The prepared slurry was coated on an aluminum foil on which carbon was coated (SDX (registered trade name), manufactured by Showa Denko K. K.) by using an applicator (350 μm gap, manufactured by Taiyu Kizai Co., Ltd.). After coating, a surface was allowed to dry by natural drying and, after that, dried for 30 minutes on a hot plate at 100° C. Thus, a positive electrode for a sulfide-based solid-state battery was prepared.

As a negative electrode active material, MF-6 (manufactured by Mitsubishi Chemical Co., Ltd.) was prepared, and, as a binder, amino-modified hydrogenated butadiene rubber (ABR)-based binder (manufactured by JSR Corporation) was prepared. Solid contents were prepared so that a weight ratio of an active material and a sulfide-based solid electrolyte material was 58:42 and a binder was 1.1 parts by weight with respect to 100 parts by weight of an active material. A solvent the same as that used in the positive electrode and the solid contents were prepared so that a solid content ratio was 63% by weight, the mixture was kneaded with a ultrasonic homogenizer (UH-50 manufactured by SMT Corporation), thereby a slurry for forming a negative electrode active material layer was obtained. By coating the slurry for forming a negative electrode active material layer on a copper foil by using an applicator and by drying, a negative electrode active material layer was formed. By punching the copper foil and negative electrode active material layer in 1 cm², a negative electrode for a sulfide-based solid-state battery was prepared.

A solid electrolyte layer was prepared as follow. Under an inert gas atmosphere, with respect to 100 parts by weight of the sulfide solid electrolyte material, 1 parts by weight of the ABR-based binder was added, further dehydrated heptane was added therein so that a solid content may be 35% by weight. This mixture was kneaded by using a ultrasonic homogenizer (UH-50 manufactured by SMT Corporation) to obtain a slurry for forming a solid electrolyte layer. A slurry for forming a solid electrolyte layer was coated on an aluminum foil by using an applicator, and then dried to obtain a solid electrolyte layer. The aluminum foil and solid electrolyte layer were punched into 1 cm² and the aluminum foil was peeled. The prepared positive electrode for a sulfide-based solid-state battery was stuck on one surface of a solid electrolyte layer so that a surface on which the slurry for a positive electrode for a sulfide-based solid-state battery was coated may come into contact with the solid electrolyte layer. The prepared negative electrode for a sulfide-based solid-state battery was stuck on the other surface of a solid electrolyte layer so that a surface on which the slurry for forming a negative electrode active material layer is coated may come into contact with the solid electrolyte layer and pressed under 4.3 ton, thereby a sulfide-based solid-state battery according to Example 1 was manufactured.

### Example 2

Except that a content ratio in a dry volume of a slurry for a positive electrode for a sulfide-based solid-state battery was changed to a positive electrode active material:a sulfide-based solid electrolyte:a binder:a conductive auxiliary agent=55.0% by volume:36.7% by volume:4.3% by volume:4.0% by volume, a slurry for a positive electrode for a sulfide-based solid-state battery was prepared in a manner the same as that of Example 1. After that, a positive electrode for a sulfide-based solid-state battery and a negative electrode for a sulfide-based solid-state battery were prepared in a manner the same as that of Example 1. Then, a sulfide-based solid-state battery according to Example 2 was manufactured by using a solid electrolyte layer the same as that of Example 1 in addition to the electrodes.

### Example 3

Except that a content ratio in a dry volume of a slurry for a positive electrode for a sulfide-based solid-state battery was changed to a positive electrode active material:a sulfide-based solid electrolyte:a binder:a conductive auxiliary agent=53.5% by volume:35.6% by volume:7.1% by volume:3.8% by volume, a slurry for a positive electrode for a sulfide-based solid-state battery was prepared in a manner the same as that of Example 1. After that, a positive electrode for a sulfide-based solid-state battery and a negative electrode for a sulfide-based solid-state battery were prepared in a manner the same as that of Example 1. Then, a sulfide-based solid-state battery according to Example 3 was manufactured by using a solid electrolyte layer the same as that of Example 1 in addition to the electrodes.

### Example 4

A positive electrode active material coated with LiNbO₃ was prepared. By using a rolling and fluidizing coating machine (manufactured by POWREX Corporation), LiNbO₃ was coated on a positive electrode active material (LiNi_{1/3}Co_{1/3}Mn_{1/3}O₂) having an average particle size of 4 μm under atmosphere, and fired under atmosphere. The LiNi_{1/3}Co_{1/3}Mn_{1/3}O₂ coated with LiNbO₃ was used as a positive electrode active material. A fluorine-based copolymer (vinylidene fluoride monomer unit:tetrafluoroethylene monomer unit:hexafluoropropylene monomer unit=55% by mol: 25% by mol: 20% by mol, manufactured by Kureha Corporation) was used as a binder:Li₂S—P₂S₅ glass ceramic containing LiI was used as a sulfide-based solid electrolyte (average particle size 2.5 μm). A vapor phase growth carbon fiber (VGCF, manufactured by Shown Denko Co., Ltd.) was used as a conductive auxiliary agent. Butyl butyrate that is one kind of ester compound was used as a solvent. A positive electrode active material, a butyl butyrate solution of 5% by weight of a binder, a sulfide-based solid electrolyte, and butyl butyrate (manufactured by Tokyo Kasei Kogyo Co., Ltd.) were mixed so that a solid content was 63% by weight. The resulted mixture was subjected to ultrasonic treatment for 30 seconds with a ultrasonic homogenizer (UH-50 manufactured by SMT Corporation). Subsequently, the mixture was stirred by shaking for 3 minutes with a shaker (TTM-1 manufactured by Shibata Scientific Technology Ltd.). Further, the mixture was subjected to ultrasonic treatment for 30 seconds with a ultrasonic homogenizer (UH-50 manufactured by SMT Corporation), and a slurry for a positive electrode for a sulfide-based solid-state battery was obtained. When a dry volume of a slurry for a positive electrode for a sulfide-based solid-state battery is set to 100% by volume, a content ratio of the binder was 1.4% by volume.

The prepared slurry was coated on a foil obtained by coating carbon on an aluminum foil (SDX (registered trade name) manufactured by Showa Denko Co., Ltd.) by using an applicator (350 μm gap, manufactured by Taiyu Kizai Co., Ltd.). After the surface of the coated foil was allowed to dry naturally, the coated foil was dried for 30 minutes on a hot plate at 100° C. Thus, a positive electrode for a sulfide-based solid-state battery was prepared.

Natural graphite carbon having an average particle size of 10 μm (manufactured by Mitsubishi Chemical Co., Ltd.) was prepared as a negative electrode active material. An amino-modified hydrogenated butadiene rubber (ABR)-based binder (manufactured by JSR Corporation) was prepared as a binder. Li₂S—P₂S₅-based glass ceramic containing LiI was prepared as a sulfide-based solid electrolyte (average particle size 2.5 μm). Heptane were prepared as a solvent. In a reactor, a negative electrode active material, a heptane solution of 5% by weight of a binder, a sulfide-based solid electrolyte, and a solvent were added, and the mixture was subjected to ultrasonic treatment for 30 seconds with a ultrasonic homogenizer (UH-50 manufactured by SMT Corporation). Subsequently, the mixture was stirred by shaking for 30 minutes with a shaker (TTM-1 manufactured by Shibata Scientific Technology Ltd.) to obtain a slurry for a negative electrode for a sulfide-based solid-state battery. The slurry for a negative electrode for a sulfide-based solid-state battery was coated on a copper foil with an applicator and dried to form a negative electrode active material layer. After the surface of the coated foil was allowed to dry naturally, the coated foil was dried for 30 minutes on a hot plate at 100° C. Thus, a negative electrode for sulfide-based solid-state battery was prepared.

Li₂S—P₂S₅ glass ceramic containing LiI was prepared as a sulfide-based solid electrolyte (average particle size 2.5 μm). A butylene rubber (BR)-based binder was prepared as a binder. Heptane was prepared as a solvent. A sulfide-based solid electrolyte, a heptane solution of a 5% by weight of binder, and a solvent were added in a reactor, and the mixture was subjected to ultrasonic treatment for 30 seconds with a ultrasonic homogenizer (UH-50 manufactured by SMT Corporation). Subsequently, the mixture was stirred by shaking for 30 minutes with a shaker (TTM-1 manufactured by Shibata Scientific Technology Ltd.) to obtain a slurry for a solid electrolyte layer. The slurry for forming a solid electrolyte layer was coated on an aluminum foil by using an applicator and dried to obtain a solid electrolyte layer. An aluminum foil and a solid electrolyte layer were punched into 1 cm² and the aluminum foil was peeled. The solid electrolyte layer was added in a metal mold having a bottom surface of 1 cm², and the solid electrolyte layer was pressed under 1 ton/cm² to prepare a separate layer. A positive electrode for a sulfide-based solid-state battery was added in a metal mold so as to come into contact with one surface of a separate layer and pressed under 1 ton/cm². Further, a negative electrode for a sulfide-based solid-state battery was added in a metal mold so as to come into contact with the other surface of a separate layer and pressed under 6 ton/cm². Thus, a sulfide-based solid-state battery according to Example 4 was manufactured.

### Example 5

Except that, when a dry volume of a slurry for a positive electrode for a sulfide-based solid-state battery was set to 100% by volume, a content ratio of a binder was set to 4.0% by volume, a slurry for a positive electrode for a sulfide-based solid-state battery was prepared in a manner the same as that of Example 4. After that, a positive electrode for a sulfide-based solid-state battery and a negative electrode for a sulfide-based solid-state battery were prepared in a manner the same as that of Example 4. Then, a sulfide-based solid-state battery according to Example 5 was manufactured by using, in addition to the electrodes, a solid electrolyte layer the same as that of Example 4.

### Example 6

Except that, when a dry volume of a slurry for a positive electrode for a sulfide-based solid-state battery is set to 100% by volume, a content ratio of a binder was set to 6.6% by volume, a slurry for a positive electrode for a sulfide-based solid-state battery was prepared in a manner the same as that of Example 4. After that, a positive electrode for a sulfide-based solid-state battery and a negative electrode for a sulfide-based solid-state battery were prepared in a manner the same as that of Example 4. Then, a sulfide-based solid-state battery according to Example 6 was manufactured by using, in addition to the electrodes, a solid electrolyte layer the same as that of Example 4.

### Comparative Example 1

A ternary active material LiCo_{1/3}Ni_{1/3}Mn_{1/3}O₂ (manufactured by Nichia Corporation) was used as a positive electrode active material. An amino-modified hydrogenated butadiene rubber (ABR)-based binder (manufactured by JSR Corporation) was used as a binder. LiI—Li₂O—Li₂S—P₂S₅ was used as a sulfide-based solid electrolyte. Heptane (manufactured by Nacalai Tesque Inc.) and tri-n-butylamine (manufacture by Nacalai Tesque Inc.) were used as a solvent. A positive electrode active material, a heptane solution of 5% by weight of a binder, a sulfide-based solid electrolyte, and heptane and tri-n-butylamine were mixed. The resulted mixture was subjected to ultrasonic treatment for 30 seconds, and then the resulted mixture was stirred for 30 minutes with a shaker to prepare a slurry for a positive electrode for a sulfide-based solid-state battery. A content ratio in a dry volume in a slurry for a positive electrode for a sulfide-based solid-state battery was a positive electrode active material:a sulfide-based solid electrolyte:a binder:a conductive auxiliary agent=55.2% by volume, 36.8% by volume:4.0% by volume:4.0% by volume. After that, a positive electrode for a sulfide-based solid-state battery and a negative electrode for a sulfide-based solid-state battery were prepared in a manner the same as that of Example 1. Then, a sulfide-based solid-state battery according to Comparative Example 1 was manufactured by using, in addition to these electrodes, a solid electrolyte layer the same as that of Example 1.

### Comparative Example 2

Except that a content ratio in a dry volume of a slurry for a positive electrode for a sulfide-based solid-state battery was set to a positive electrode active material:a sulfide-based solid electrolyte:a binder:a conductive auxiliary agent=54.5% by volume:36.4% by volume:5.2% by volume:3.9% by volume, a slurry for a positive electrode for a sulfide-based solid-state battery was prepared in a manner the same as that of Comparative Example 1. After that, a positive electrode for a sulfide-based solid-state battery and a negative electrode for a sulfide-based solid-state battery were prepared in a manner the same as that of Example 1. Then, a sulfide-based solid-state battery of Comparative Example 2 was manufactured by using, in addition to these electrodes, a solid electrolyte layer the same as that of Example 1.

### Comparative Example 3

Except that a content ratio in a dry volume of a slurry for a positive electrode for a sulfide-based solid-state battery was set to a positive electrode active material:a sulfide-based solid electrolyte:a binder:a conductive auxiliary agent=53.8% by volume:35.9% by volume:6.4% by volume:3.9% by volume, a slurry for a positive electrode for a sulfide-based solid-state battery was prepared in a manner the same as that of Comparative Example 1. After that, a positive electrode for a sulfide-based solid-state battery and a negative electrode for a sulfide-based solid-state battery were prepared in a manner the same as that of Example 1. Then, a sulfide-based solid-state battery of Comparative Example 3 was manufactured by using, in addition to these electrodes, a solid electrolyte layer the same as that of Example 1.

### Comparative Example 4

Except that a content ratio in a dry volume of a slurry for a positive electrode for a sulfide-based solid-state battery was set to a positive electrode active material:a sulfide-based solid electrolyte:a binder:a conductive auxiliary agent=52.4% by volume:35.0% by volume:8.8% by volume:3.8% by volume, a slurry for a positive electrode for a sulfide-based solid-state battery was prepared in a manner the same as that of Comparative Example 1. After that, a positive electrode for a sulfide-based solid-state battery and a negative electrode for a sulfide-based solid-state battery were prepared in a manner the same as that of Example 1. Then, a sulfide-based solid-state battery of Comparative Example 4 was manufactured by using, in addition to these electrodes, a solid electrolyte layer the same as that of Example 1.

### Comparative Example 5

A positive electrode active material coated with LiNbO₃ was prepared. By using a rolling and fluidizing coating machine (manufactured by POWREX Corporation), LiNbO₃ was coated, under atmosphere, on a positive electrode active material (LiNi_{1/3}Co_{1/3}Mn_{1/3}O₂) having an average particle size of 4 μm and fired under atmosphere. The LiNi_{1/3}Co_{1/3}Mn_{1/3}O₂ coated with LiNbO₃ was used as a positive electrode active material. An amino-modified hydrogenated butadiene rubber (ABR)-based binder (manufactured by JSR Corporation) was used as a binder. Li₂S—P₂S₅ glass ceramic containing LiI was used as a sulfide-based solid electrolyte (average particle size 2.5 μm). A vapor phase growth carbon fiber (VGCF, manufactured by Showa Denko Co., Ltd.) was used as a conductive auxiliary agent. Heptane was used as a solvent. A positive electrode active material, a heptane solution of 5% by weight of a binder, a sulfide-based solid electrolyte, and heptane were mixed so that a solid content was 63% by weight. The resulted mixture was subjected to ultrasonic treatment for 30 seconds with an ultrasonic homogenizer (UH-50 manufactured by SMT Corporation). Subsequently, the mixture was stirred by shaking for 3 minutes with a shaker (TTM-manufactured by Shibata Scientific Technology Ltd.). Further, the mixture was subjected to ultrasonic treatment for 30 seconds with an ultrasonic homogenizer (UH-50 manufactured by SMT Corporation), and a slurry for a positive electrode for a sulfide-based solid-state battery was obtained. When a dry volume of a slurry for a positive electrode for a sulfide-based solid-state battery is set to 100% by volume, a content ratio of the binder was 4.0% by volume. After that, a positive electrode for a sulfide-based solid-state battery and a negative electrode for a sulfide-based solid-state battery were prepared in a manner the same as that of Example 4. Then, a sulfide-based solid-state battery of Comparative Example 5 was manufactured by using, in addition to these electrodes, a solid electrolyte layer the same as that of Example 4.

### 2. Measurement of Adhesion Force

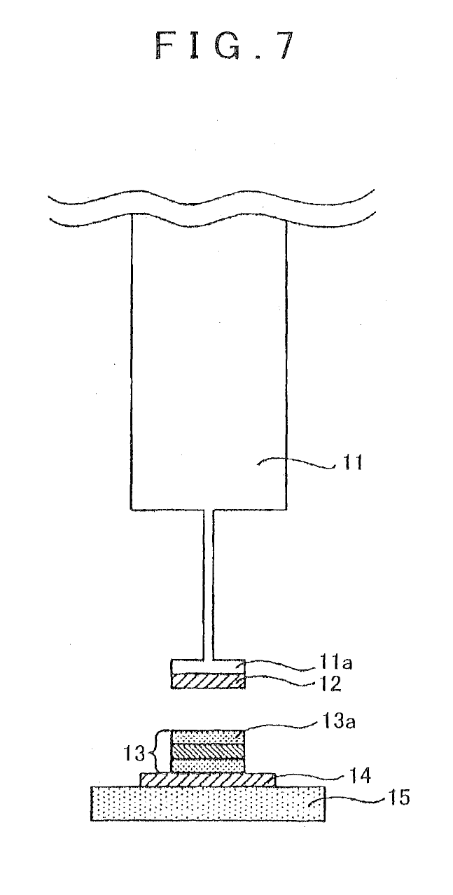

An adhesion force of each of sulfide-based solid-state batteries of Examples 1 to 3 and Comparative Examples 1 to 3 was measured. An adhesion force was measured with a tension load meter (Model-2257 manufactured by AICHI Engineering Co., Ltd.) in a glove box under argon atmosphere at room temperature. FIG. 7 is a sectional schematic diagram roughly showing a measurement mode of an adhesion force. In FIG. 7, a double wavy line means an omission of the drawing. Firstly, with a positive electrode side 13a in a sulfide-based solid-state battery up, a sulfide-based solid-state battery 13 was fixed to a pedestal 15 with a double-sided tape 14. Another double-sided tape 12 was stuck to an apical end 11a of an attachment of a tensile load meter 11, and an adhesive surface of the double-sided tape was directed to a side of the sulfide-based solid-state battery 13. Then, the tensile load meter 11 was vertically lowered at a constant speed (about 20 mm/min) with respect to the sulfide-based solid-state battery 13. After bringing the double-sided tape 12 into contact with a positive electrode side 13a in the sulfide-based solid-state battery, the tensile load meter 11 was elevated. A tensile load when a coated film of a slurry for a positive electrode for a sulfide-based solid-state battery was peeled was taken as an adhesion force of the sample.

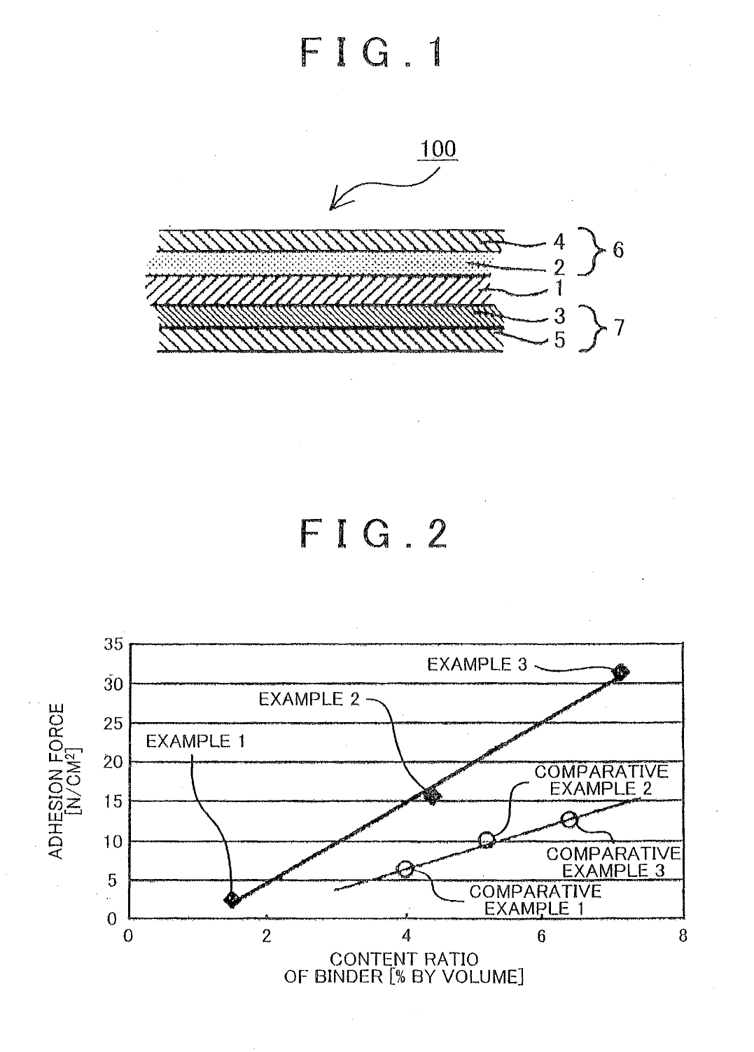

FIG. 2 is a graph where adhesion forces of sulfide-based solid-state batteries of Example 1 to Example 3 and Comparative Example 1 to Comparative Example 3 are plotted. FIG. 2 is a graph where a content ratio (% by volume) of a binder and an adhesion force (N/cm²) are shown respectively in a horizontal axis and in a vertical axis. A plot of black rhombuses shows data of sulfide-based solid-state batteries where a fluorine-based copolymer was used as a binder (Example 1 to Example 3). A plot of white circles shows data of sulfide-based solid-state batteries where an ABR-based binder was used as a binder (Comparative Example 1 to Comparative Example 3). A thick solid line in the graph shows a least square line of the plot of black rhombuses and a thin solid line in the graph shows a least square line of the plot of white circles.

As is obvious from FIG. 2, an adhesion force of Comparative Example 1 (content ratio of binder: 4.0% by volume) is 6.3 N/cm². An adhesion force of Comparative Example 2 (content ratio of binder: 5.2% by volume) is 10 N/cm². An adhesion force of Comparative Example 3 (content ratio of binder: 6.4% by volume) is 12.7 N/cm².

On the other hand, as is obvious from FIG. 2, an adhesion force of Example 1 (content ratio of binder: 1.5% by volume) is 2.4 N/cm². Accordingly, an adhesion force of Example 1 exceeds 1.8 N/cm² that is a reference value of a usable sulfide-based solid-state battery. Further, an adhesion force of Example 2 (content ratio of binder: 4.3% by volume) is 15.7 N/cm² and an adhesion force of Example 3 (content ratio of binder: 7.1% by volume) is 31.5 N/cm². From what was described above, adhesion forces of the sulfide-based solid-state batteries of Example 1 to Example 3 where a fluorine-based copolymer was used as a binder are considered higher than adhesion forces of the sulfide-based solid-state batteries where an ABR-based binder was used at the same content ratio. Further, it can be confirmed that, irrespective of a kind of a binder, as a content ratio of a binder is increased, an adhesion force becomes stronger.

### 3. Measurement of Output

### 3-1. Example 1 to Example 3 and Comparative Example 1 to Comparative Example 4

Outputs of sulfide-based solid-state batteries of Example 1 to Example 3 and Comparative Example 1 to Comparative Example 4 were measured and output ratios thereof were calculated. Specifically, alter. SOC adjustment at a voltage of 3.6 V, a constant power discharge was conducted (20 to 100 mW, at an increment of 10 mW), and an electric power corresponding to 5 seconds was taken as an output. An output ratio is a ratio of a measured battery output with respect to an output of a battery of Comparative Example 1. That is, an output ratio is a ratio of a measured battery output when an output of a battery of Comparative Example 1 is set to 1.

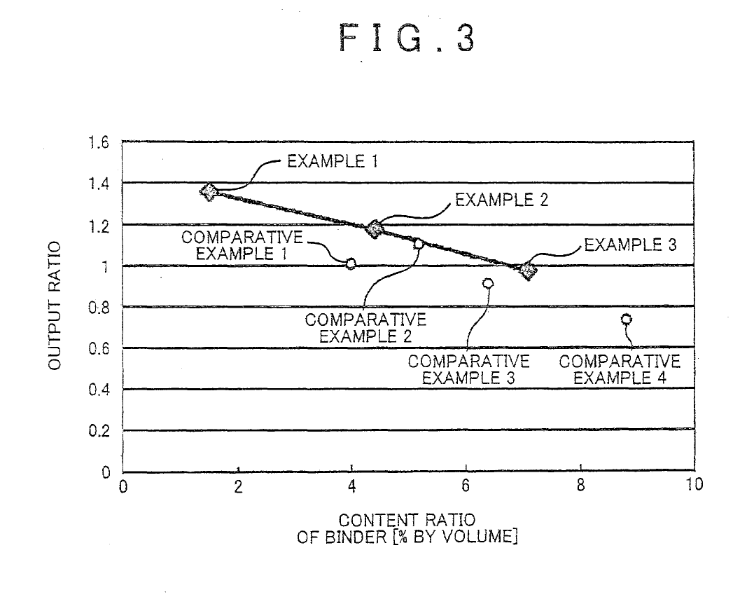

FIG. 3 is a graph where output ratios of sulfide-based solid-state batteries of Example 1 to Example 3 and Comparative Example 1 to Comparative Example 4 are plotted. In FIG. 3, a horizontal axis and a vertical axis respectively show a content ratio of a binder (% by volume) and an output ratio. A plot of black rhombuses shows data of sulfide-based solid-state batteries where a fluorine-based copolymer was used as a binder (Example 1 to Example 3). A plot of white circles shows data of sulfide-based solid-state batteries where an ABR-based binder was used as a binder (Comparative Example 1 to Comparative Example 4). Further, a thick solid line in the graph shows a least square line of a plot of black rhombuses.

As is obvious from FIG. 3, an output ratio of Comparative Example 2 (content ratio of binder: 5.2% by weight) is 1.09. An output ratio of Comparative Example 3 (content ratio of binder: 6.4% by weight) is 0.9. An output ratio of Comparative Example 4 (content ratio of binder: 8.8% by weight) is 0.71. From what was described above, it is found that output ratios of sulfide-based solid-state batteries of Comparative Example 1 to Comparative Example 4, where an ABR-based binder was used as a binder, take the maximum value when a content ratio of the binder is about 5% by volume. When a content ratio of an ABR-based binder is smaller than about 5% by volume; it is considered that, since adhesiveness in a mixture is low, a gap is generated between particles to be difficult to obtain an output. On the other hand, when a content ratio of the ABR-based binder is larger than about 5% by volume, it is considered that an abundant ABR-based binder is present between positive electrode material particles to disturb lithium conduction and electron conduction.

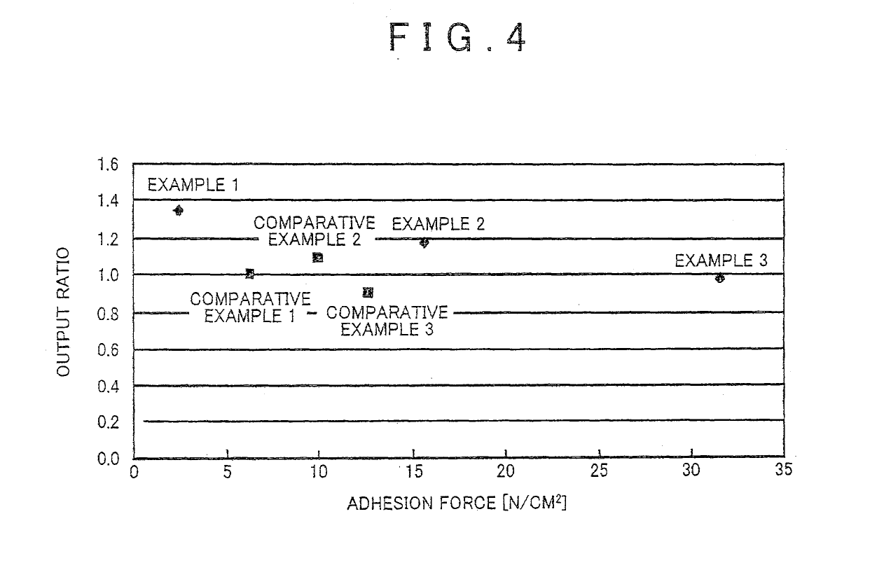

By contrast, as obvious from FIG. 3, an output ratio of Example 1 (content ratio of binder: 1.5% by volume) is 1.35. An output ratio of Example 2 (content ratio of binder: 4.3% by volume) is 1.17. An output ratio of Example 3 (content ratio of binder: 7.1% by volume) is 0.97. From what was described above, it is found that output ratios of sulfide-based solid-state batteries of Example 1 to Example 3, where a fluorine-based copolymer was used as a binder, decrease as the content ratio of the binder increases. A fluorine-based copolymer allows to obtain sufficient adhesiveness and high output even at a slight amount. On the other hand, it is considered that, when a fluorine-based copolymer is present too much, the fluorine-based copolymer is present much between positive electrode material particles to may disturb lithium conduction and electron conduction. Like this, it is found that sulfide-based solid-state batteries of Example 1 to Example 3, in each of which a fluorine-based copolymer is used as a binder, exert an output higher than that of sulfide-based solid-state batteries of Comparative Example 1 to Comparative Example 4 in each of which an ABR-based binder is used as a binder. Further, in Example 1 to Example 3, an output ratio does not abruptly decrease when a content ratio increases. Therefore, it is assumed that, in Example 1 to Example 3, there is no fear that an anomalous chemical reaction occurs between a sulfide-based solid electrolyte and a binder to result in decreasing an output of a sulfide-based solid-state battery. FIG. 4 is a graph where, output ratios are plotted with respect to adhesion forces of sulfide-based solid-state batteries of Example 1 to Example 3 and Comparative Example 1 to Comparative Example 3. In FIG. 4, a vertical axis and a horizontal axis respectively show an output ratio and an adhesion force (N/cm²). From FIG. 4, it is found that in Comparative Example 1 to Comparative Example 3, even when an adhesion force is less than 15 N/cm², an output ratio is smaller than 1. That is, a decrease of an output ratio is large. On the other hand, from FIG. 4, it is found that, even when an adhesion force exceeds 30 N/cm², a decrease in output ratio is not so much in each of Example 1 to Example 3. Accordingly, it is found that a fluorine-based copolymer used in the embodiments of the invention can improve an adhesion force without deteriorating an output ratio while, when a conventional ABR-based binder is used, an output ratio is decreased as an adhesion force is improved.

From what was described above, it is found that sulfide-based solid-state batteries of Example 1 to Example 3 can combine a sufficient output with a high adhesion force compared with a sulfide-based solid-state battery where a conventional ABR-based binder is used as a binder. In the sulfide-based solid-state batteries of Example 1 to Example 3, a positive electrode contains a fluorine-based copolymer containing vinylidene fluoride monomer units and a positive electrode active material, and, when a volume of a positive electrode is set to 100% by volume, a content ratio of the fluorine-based copolymer is 1.5 to 10% by volume.

### 3-2. Example 4 to Example 6, and, Comparative Example 5

An initial output of each of sulfide-based solid-state batteries of Example 4 to Example 6 and Comparative Example 5 was measured. Specifically, each of sulfide-based solid-state batteries of Example 4 to Example 6 and Comparative Example 5 was firstly charged until 3.6 V at a constant current-constant voltage (corresponding to a termination current of 1/100 C). Then, the operation was stopped for 10 minutes. Subsequently, a constant power discharge was conducted, and, an electric power value (W) by which the voltage of each of the batteries reaches 2.5 V during 5 seconds was taken as an initial output.

FIG. 5 is a graph where initial outputs and initial capacities of sulfide-based solid-state batteries of Example 4 to Example 6 are plotted. FIG. 5 is a graph where a content ratio (% by volume) of a binder and an initial output or an initial capacity respectively are shown in a horizontal axis and in a vertical axis. Further, a plot of rhombuses shows data of initial outputs of the respective batteries. A plot of triangles shows data of initial capacities of the respective batteries. Initial outputs and initial capacities in FIG. 5 are shown by a ratio when an initial output or an initial capacity of Example 4 (content ratio of binder: 1.4% by volume) is set to 100. The initial capacity in FIG. 5 will be discussed below.

As obvious from the plot of rhombuses of FIG. 5, when an initial output of Example 4 (content ratio of binder: 1.4% by volume) is set to 100, an initial output of Example 5 (content ratio of binder: 4.0% by volume) is 87, and an initial output of Example 6 (content ratio of binder: 6.6% by volume) is 73. From what was described above, it is found that, in an initial stage, the smaller the content ratio of a binder is, the higher the output is.

Next, an output after endurance of each of sulfide-based solid-state batteries of Example 4 to Example 6 and Comparative Example 5 was measured. Specifically, (1) firstly, a constant-current charge was conducted up to 4.4 V at 0.5 hour rate (2 C). (2) Then, the operation was stopped for 10 minutes. (3) Subsequently, a constant-current discharge was conducted up to 3.4 V at 0.5 hour rate (2 C). (4) Subsequently, the operation was stopped for 10 minutes. The operations of (1) to (4) were conducted 2000 cycles under a temperature condition of 60° C., an output after 2000 cycles was measured, and an output at this time was taken as an output after endurance. In the middle of 2000 cycles, capacity confirmation and output measurements were conducted several times.

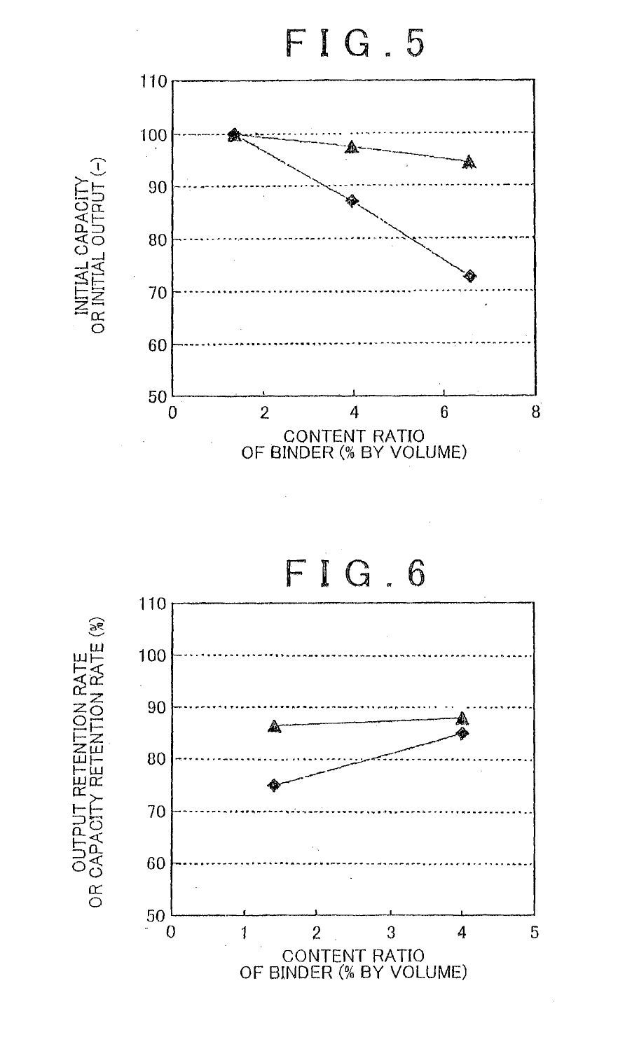

FIG. 6 is a graph where output retention rates and capacity retention rates after endurance of sulfide-based solid-state batteries of Example 4 and Example 5 are plotted. FIG. 6 shows a graph where a horizontal axis and a vertical axis respectively represent a content ratio (% by volume) of a binder and an output retention rate or a capacity retention rate (%). Further, a plot of rhombuses shows data of output retention rates of the respective batteries, and a plot of triangles shows data of capacity retention rates of the respective batteries. The output retention rate and capacity retention rate in FIG. 6 are rates (%) of output or capacity after 2000 cycles when an initial output or an initial capacity of each of batteries is set to 100%. The capacity retention rate in FIG. 6 will be discussed below.

As is obvious from FIG. 6, an output retention rate of Example 4 (content ratio of binder: 1.4% by volume) is 75%, and an output retention rate of Example 5 (content ratio of binder: 4.0% by volume) is 85%. From what was described above, it is found that the larger the content ratio of a binder is, the higher the output retention rate is.

Table 1 below is a table where respective initial outputs and outputs after endurance of Example 5 (content ratio of fluorine-based copolymer: 4.0% by volume) and Comparative Example 5 (content ratio of ABR-based binder: 4.0% by volume) are summarized. In Table 1 below, initial outputs and outputs after endurance are shown as a ratio when an initial output of Comparative Example 5 is set to 100.

TABLE 1

| | Initial Output | Output After Endurance |
|---|---|---|
| Example 5 | 91 | 63 |
| Comparative Example 5 | 100 | 56 |

From the Table 1, when an initial output of Comparative Example 5 is set to 100, an initial output of Example 5 is 91. On the other hand, while an output after endurance of Comparative Example 5 is 56, an output after endurance of Example 5 is high such as 63. It is found from what was described above that a sulfide-based solid-state battery of Example 5, in which a fluorine-based copolymer was used in a positive electrode, as a result of improved durability, has a higher output retention rate compared with that of a sulfide-based solid-state battery of Comparative Example 5, in which an ABR-based binder was used in a positive electrode.

### 4. Measurement of Capacity

An initial capacity of each of sulfide-based solid-state batteries of Example 4 to Example 6 and Comparative Example 5 was measured. Specifically, each of sulfide-based solid-state batteries of Example 4 to Example 6 and Comparative Example 5 is firstly charged at a constant current-constant voltage charge at 3 hour rate (⅓ C) up to 4.55 V. Then, the operation was stopped for 10 minutes. Subsequently, each of the batteries was discharged at a constant power at 3 hour rate (⅓C) up to 3.0 V and a discharge capacity of each of the batteries at this time was taken as an initial capacity.

As obvious from a plot of triangles of FIG. 5, when an initial capacity of Example 4 (content ratio of binder: 1.4% by volume) is set to 100, an initial capacity of Example 5 (content ratio of binder: 4.0% by volume) is 98, and an initial capacity of Example 6 (content ratio of binder: 6.6% by volume) is 95. From what was described above, it is found that in an initial stage, the smaller the content ratio of a binder is, the higher the capacity is.

Next, capacities after endurance of sulfide-based solid-state batteries of Example 4 to Example 6 and Comparative Example 5 were measured. Specifically, in a manner the same as that of the measurement of output after endurance, the operations of the (1) to (4) were conducted 2000 cycles under a temperature condition of 60° C. and a capacity after 2000 cycles was measured, and a capacity of each of the batteries at this time was taken as a capacity after endurance. In the middle of 2,000 cycles, capacity confirmation and output measurement were conducted several times.

As is obvious from a plot of triangles of FIG. 6, a capacity retention rate of Example 4 (content ratio of binder: 1.4% by volume) is 86% and a capacity retention rate of Example 5 (content ratio of binder: 4.0% by volume) is 88%. From what was described above, it is found that the larger the content ratio of a binder is, the higher the capacity retention rate is.

Table 2 below is a table where respective initial capacities and capacities after endurance of Example 5 (content ratio of fluorine-based copolymer: 4.0% by volume) and Comparative Example 5 (content ratio of ABR-based binder: 4.0% by volume) are summarized. In Table 2 below, initial capacities and capacities after endurance are shown as a ratio when an initial capacity of Comparative Example 5 is set to 100.

TABLE 2

| | Initial Capacity | Capacity After Endurance |
|---|---|---|
| Example 5 | 100 | 86 |
| Comparative Example 5 | 100 | 80 |

From Table 2 above, it is found that, when an initial capacity of Comparative Example 5 is set to 100, an initial capacity of Example 5 is 100. That is, two sulfide-based solid-state batteries have initial capacities of the same level. On the other hand, while a capacity after endurance of Comparative Example 5 is 80, a capacity after endurance of Example 5 is such high as 86. From what was described above, it is found that a sulfide-based solid-state battery of Example 5, as a result of improved durability, has a higher capacity retention rate compared with that of a sulfide-based solid-state battery of Comparative Example 5. As described above, a fluorine-based copolymer was used in a positive electrode in the sulfide-based solid-state battery of Example 5, and an ABR-based binder was used in a positive electrode in the sulfide-based solid-state battery of Comparative Example 5.

### 5. Preparation of Green Pellet

### Manufacture Example 1

100 mg of LiI—Li₂O—Li₂S—P₂S₅ that is a kind of sulfide-based solid electrolyte and 5 ml of butyl butyrate (manufactured by Tokyo Kasei Kogyo Co., Ltd.) that is a kind of ester compound were mixed and the mixture was dried. The dried mixture was pelletized under pressure of 4.3 ton/cm² to prepare a green pellet of Manufacture Example 1.

### Manufacture Example 2

Except that, in Manufacture Example 1, 5 ml of butyl butyrate was changed to 5 ml of N-methyl pyrrolidone (NMP, manufactured by Nacalai Tesque Inc.), in a manner the same as that of Manufacture Example 1, raw materials were mixed, dried and pelletized to prepare a green pellet of Manufacture Example 2.

### 6. Measurement of Ionic Conductivity

An AC impedance measurement was conducted of each of green pellets of Manufacture Example 1 and Manufacture Example 2 at a frequency of 1 MHz to 0.1 Hz using an impedance analyzer (SI-1260 manufactured by Solartron), and based on measurement results, ionic conductivity was calculated. Table 3 below is a table where ionic conductivities of green pellets of Manufacture Example 1 and Manufacture Example 2 are summarized.

TABLE 3

| | Solvent | Ionic Conductivity |
|---|---|---|
| | or Dispersion Medium | (S/cm) |
| Manufacture Example 1 | Butyl butyrate | 9.3 × 10⁻⁴ |
| Manufacture Example 2 | NMP | 7.64 × 10⁻⁸ |

As obvious from the Table 3, while ionic conductivity of a green pellet of Manufacture Example 2 where NMP was used is 7.64×10⁻⁸ S/cm, ionic conductivity of a green pellet of Manufacture Example 1 where butyl butyrate was used is 9.3×10⁻⁴ S/cm. That is, ionic conductivity of Manufacture Example 1 is four orders of magnitude higher than ionic conductivity of Manufacture Example 2. From these results, it is indicated that butyl butyrate is lower in the reactivity with a sulfide-based solid electrolyte compared with that of NMP, and, as a result, does not decrease ionic conductivity of a sulfide-based solid electrolyte.

1. A slurry for a positive electrode for a sulfide-based solid-state battery comprising: a fluorine-based copolymer containing vinylidene fluoride monomer units;
a positive, electrode active material;
a solvent or a dispersion medium; and
wherein when a dry volume of the slurry is set to 100% by volume, a content ratio of the fluorine-based copolymer is 1.5 to 10% by volume, and
the solvent or dispersion medium contains an ester compound represented by the following formula:
R¹—CO₂R²
wherein R¹ represents a straight-chain or branched-chain aliphatic group having 3 to 10 carbon atoms or an aromatic group having 6 to 10 carbon atoms, and
R² represents a straight-chain or branched-chain aliphatic group having 4 to 10 carbon atoms.

2. The slurry according to claim 1,
wherein a content ratio of the vinylidene fluoride monomer units in the fluorine-based, copolymer is 40 to 70% by mol.

3. The slurry according to claim 1,
wherein the fluorine-based copolymer further contains at least one fluorine-based monomer unit selected from the group consisting of a letrafluoroethylene monomer unit, a hexafluoropropylene monome unit, a vinyl fluoride monomer unit, a trifluoroethylene monomer unit, a chlorotrifluoroethylene monomer unit, a perfluoromethylvinylether monomer unit, and a perfluoroethylvinylether monomer unit,

4-5. (canceled)

6. The slurry according to claim 1,
wherein when the dry volume is set to 100% by volume, the content ratio of the lluorine-based copolymer is 1.5 to 4.0% by volume,

7-12. (canceled)

13. A method for manufacturing a positive electrode for a sulfide-based solid-state battery, the positive electrode including a positive electrode active material and a fluorine-based copolymer containing vinylidene fluoride monomer units, the method comprising:
preparing a base material;
kneading at least the fluorine-based copolymer, the positive electrode active material, and a solvent or a dispersion medium to prepare a slurry, wherein when a dry volume of the slurry in a manufactured positive electrode for the sulfide-based solid-state battery is set to 100% by volume, a content ratio of the fluorine-based copolymer is 1.5 to 10% by volume in the slurry; and
coating the slurry on at least any one surface of the base material to form the positive electrode for the sulfide-based solid-state battery,
wherein the slurry further contains a sulfide-based solid electrolyte, and
the solvent or dispersion medium contains an ester compound represented by the following formula:
R¹—CO₂—R²
wherein R¹ represents a straight-chain or branched-chain aliphatic group having 3 to 10 carbon atoms or an aromatic group having 6 to 10 carbon atoms, and
R² represents a straight-chain or branched-chain aliphatic group having 4 to 10 carbon atoms.

14. The method for manufacturing the positive electrode for the sulfide-based solid-state battery according to claim 13,
wherein a content ratio of the vinylidene fluoride monomer units in the fluorine-based copolymer is 40 to 70%) by mol.

15. The method for manufacturing the positive electrode for the sulfide-based solid-state battery according to claim 13,
wherein the fluorine-based copolymer further contains at least one fluorine-based monomer unit selected from the group consisting of a teti afluoroethylene monomer unit, a hexafluoropropylene monomer unit, a vinyl fluoride monomer unit, a trifluoroethylene monomer unit, a chlorotrifluoroethylene monomer unit, a perfluoromethylvinylether monomer unit, and a perfluoroethylvinylether monomer unit.

16-17. (canceled)

18. The method for manufacturing the positive electrode for a sulfide-based solid-state battery according to claim 13,
wherein, when the dry volume in the manufactured positive electrode for the sulfide-based solid-state battery is set to 100% by volume, the content ratio of the fluorine-based copolymer is 1.5 to 4.0% by volume.

19. A method for manufacturing a sulfide-based solid-state battery, the sulfide-based solid-state battery including a positive electrode, a negative electrode, and a sulfide-based solid electrolyte layer interposed between the positive electrode and the negative electrode, the method comprising:
preparing the negative electrode and the sulfide-based solid electrolyte layer; kneading at least a fluorine-based copolymer containing vinylidene fluoride monomer units, a positive electrode active material, and a solvent or a dispersion medium to prepare a slurry, wherein when a dry volume of the slurry in a manufactured sulfide-based solid-state battery is set to 100% by volume, a content ratio of the fluorine-based copolymer is 1.5 to 10% by volume in the slurry; and
coating the slurry on one surface of the sulfide-based solid electrolyte layer to form the positive electrode and stacking the negative electrode on the other surface of the sulfide-based solid electrolyte layer to manufacture the sulfide-based solid-state battery,
wherein the slurry further contains a sulfide-based solid electrolyte, and
the solvent or dispersion medium contains an ester compound represented by the following formula:
R¹—CO₂—R²
wherein R¹ represents a straight-chain or branched-chain aliphatic group having 3 to 10 carbon atoms or an aromatic group having 6 to 10 carbon atoms, and
R² represents a straight-chain or branched-chain aliphatic group having 4 to 10 carbon atoms.

20. The method for manufacturing the sulfide-based solid-state battery according to claim 19,
wherein a content ratio of the vinylidene fluoride monomer units in the fluorine-based copolymer is 40 to 70% by mol.

21. The method for manufacturing the sulfide-based solid-state battery according to claim 19,
wherein the fluorine-based copolymer further contains at least one fluorine-based monomer unit selected from the group consisting of a tetrafluoroethylene monomer unit, a hexafluoropropylene monomer unit, a vinyl fluoride monomer unit, a trifluoroethylene monomer unit, a chlorotrifluoroethylene monomer unit, a peril uoromethylvinyl ether monomer unit, and a perfluoroelhylvinylelher monomer unit.

22-23. (canceled)

24. The method for manufacturing the sulfide-based solid-state battery according to claim 19,
wherein when the dry volume in the manufactured sulfide-based solid-state battery is set to 100% by volume, the content ratio of the fluorine-based copolymer is 1.5 to 4.0% by volume.
